(19) United States
(12) Patent Application Publication
(10) Pub. No.: US 2021/0291452 A1
(43) Pub. Date: Sep. 23, 2021

(54) METHOD, 3D MANUFACTURING SYSTEM, EXTRUDER HEAD THERFOR

(71) Applicant: VEDA GROUP B.V, Katwijk (NL)

(72) Inventor: Martijn Arnoud KOREVAAR, Katwijk (NL)

(21) Appl. No.: 17/057,685

(22) PCT Filed: May 22, 2019
(86) PCT No.: PCT/NL2019/000008

§ 371 Date: Nov. 22, 2020

Related U.S. Application Data
(60) Provisional application No. 62/675,060, filed on May 22, 2018.

(30) Foreign Application Priority Data
May 22, 2018 (NL) NONE

(51) Int. Cl. B29C 64/321; B33Y 10/00; B33Y 30/00; B29C 64/118; B33Y 40/00

(52) U.S. Cl. CPC B29C 64/321; B33Y 10/00; B33Y 40/00; B29C 64/118; B33Y 30/00

(57) ABSTRACT

Relates to a method of operating a 3D printer of a 3D printing based manufacturing system in which a filament (7) of printing material is driven into an extruder head by means of a drive mechanism, in which method the filament may be driven by protruding a blade (13) into the filament in a direction at least having a component transverse to the direction of drive of the filament and by subsequently driving the blade into a pre-determined direction of the filament, in particular by driving a wheel (11) or belt (19) holding said blade, as well as to a drive element for a drive mechanism of an extruder for a 3D printing, comprising a circumferential face from which drive blades protrude outward, in particular under an angle with a direction of drive, and to printing material filament, provided with incisions (13A, 13B) at a fixed, predetermined mutual distance.

### FIELD AND BACKGROUND OF THE INVENTION

The present invention relates to an improvement in a so-called 3D device manufacturing system, in popular sense also known as a 3D printer, an improved extruder therefore, in particular print material filament feeder thereof or feeder for short, and a method of manufacturing or 3D printing and of feeding a filament to a printing head.

So called 3D printing based device manufacturing systems have been out in the art ever since 1982, however have presently not only become popular in amateur or hobbyist areas for various purposes, but have also in industry become established as a professional means of producing devices or spare parts. The economic significance of these systems not only resides in the ability to relatively easily create special shapes or to quickly create prototypes for testing purposes, but also in on demand supply, saving various forms of costs like in storage, transport and administration.

The extruder, i.e. with print head and filament driver unit, alternatively denoted hot end respectively cold end, of such a system constitutes one of the vital components of such a 3D manufacturing system for reason that slippage at the filament drive causes irregular filament supply at the print head where the filament is normally extruded while being heated. Interruption by slippage causes irregular deposition of material at the object to be created, hence poor quality thereof. Equally a deteriorated filament, e.g. having any irregularity such as an altered, i.e. non-round shape, grinding spots or a varying diameter over its length leads to poor quality of the manufacturing system. So as to avoid these phenomena, quality manufacturing systems may uneconomically opt to feed the filament at relatively low speed. It may hence already for this reason be clear that the quality of an extruder, in particular the filament driver is critical to the quality of a 3D manufacturing system.

Another, equally if not more important printer feature, i.e. in view of quality of printing is the capability of securely and swiftly retracting filament. The latter is important at jumps and at end points of the print head movement over the object to be printed. At such instances the printing of heated filament should temporarily be interrupted without leakage of molten filament and without leaving traces thereof over the object. Instant stop of printing is a function of swiftly withdrawing the filament to some extent, with a view to causing under pressure as it were at the end of the print head, so as to thereby stop extrusion of molten filament and keep it within the extruder until the print head has been re-positioned. The capability in performing this function determines the neatness or quality of finishing of the workpiece produced.

Yet another advantage of the present invention is that the higher forces that may be generated therewith allow for utilization of even further reduced print nozzle size, i.e. may be utilized for even more refined level of resolution at printing, popularly denoted may by utilized for printing fine art and other such as fine industrial work pieces. In this respect relatively easy and/or swift printing is contemporary made possible with printing heads with print nozzle of 0.1 mm or smaller.

### DESCRIPTION OF THE RELATED ART

An overview of extruder technology is provided in the article a crash course on an essential component of your 3D-printer at https://www.matterhackers.com/articles/extruders-101:-a-crash-course-on-an-essential-component-of-your-3d-printer. The publication teaches amongst others that two most common “extruder implementations” include small steel gears that have been hobbed, and hobbed bolts. ‘I-lobbed’ is indicated to mean that splines or teeth have been cut into it. The gears are indicated to be mounted onto the motor shaft, and the bolts are typically driven by geared extruder motors, so as to form an in fact relatively simple, yet economic feeding mechanism. In practice however, it appears that the feeding efficiency within the known extruders is sub-optimal, at least does not sufficiently support quality, hence professional 3D printing. Incidentally, factors in such quality of product and manufacture thereof include speed and resolution of printing.

As stated by the publication US2017157826, a type of extruder “commonly and preferably used consists of a ‘cold’ end having a filament feeder unit and a ‘hot’ end having a heated extrusion nozzle. The feeder pulls filament material off a supply roll and feeds it by pressure into the heated nozzle which consists of essentially a heated tube. The feeder unit design is critical, and several variants are known: The most commonly used method is to feed the filament in a straight line between a driven pinch wheel and a sprung pressure plate or idler wheel. The pinch wheel can be knurled, toothed, hobbed or otherwise treated to increase the friction and therefore traction force applicable on the filament. For example, a toothed pinch wheel where the tooth profile is concave to provide a line contact with the filament instead of a point contact would be preferable”. This publication indicates that feeding the filament into the feeding mechanism at an angle different to the outlet angle increases frictional contact with the pinch wheel, so that a higher feeding rate may be achieved without slippage. The publication teaches the use of support rollers to keep the filament into contact with the pinch wheel over a relatively large section thereof.

Such a line contact creating concave profile has also been proposed by an earlier publication by Applicant in the RepRapWorld newsletter of end October 2015, in the section “Vaeder cold end”. The article recognizes the problem of damaging the filament at efforts to increase driving force on the filament. It also proposed to increase frictional contact by maintaining contact with a drive wheel over a large section thereof. Rather than using support rollers in combination with a pinch wheel, it teaches to use a belt and a drive wheel, so that the pinching force is altered into a pressing force between belt and wheel. While still developing an increased extrusion force, this pressing force may be kept low due to the all along contact between belt filament and wheel over the entire section of contact. Another advantage of this method of driving is that the filament has no chance of escaping from regularly reaching the printer head of extruder by e.g. buckling away between two consecutive contact rollers.

While Applicant had thus already improved on the quality and speed of existing manufacturing systems and their extruders, it is felt that still higher manufacturing speed is desired within especially high quality end manufacturing systems.

### BRIEF SUMMARY OF THE INVENTION

In the present invention a highly practical and therefore valuable improvement is made to the known 3D printing based manufacturing systems in that a new method and mechanism of driving is provided which allows high driving speed and high extrusion force without sacrificing quality by undue deformation of the filament. This improvement is achieved in a relatively simple, yet unconventional manner by using blades such as knife blades that are allowed to penetrate, preferably to cut into the filament, in particular to an extend in which the integrity of the filament is not unduely corrupted, especially in view of continuous, secure and even supply of filament material at an associated printer head, while still engaging the filament to an extend allowing the blades to effectively function as tangentially acting drive blades within the body of the filament.

This novel manner of driving a filament avoids the exertion of pinching force on the filament, grinding or other deforming effects thereon that may affect the even supply of material at the extruder. Surprisingly, while the new drive means may negatively affect the structural integrity of the filament to be driven, it appears to do so in a manner that does not affect the even distribution of material at the extruder. Rather it proves to be entirely slip free. The latter of course under normal circumstances, i.e. for as far as the nozzle or print head is not entirely blocked such as might be the case at contamination or cold extrusion.

Moreover, the new method and mechanism appears to allow factors of increase in driving speed, apparently for reason that the blades not only prevent slipping, but also secure optimal definition of the direction of the driving force when a blade is included with a radial and an axial orientation relative to the drive wheel in which it is thought to be included. When accurately produced, the effect of the latter is defined so well that the need to for a guiding belt or roller ensuring engagement of knife and filament virtually becomes superfluous for reason that the direction of action of the knife blades do not at least hardly comprise any non-tangential component. Therefore, in principle no radial counterforce or mechanism is required at driving a filament in accordance with the invention, i.e. a counter wheel, counter wheels or a counter belt as normally included may at least theoretically be refrained from.

Yet, in practice, where high driving speeds are for economic reasons preferred, a feeding counter element is provided at the initial point of engagement between filament and driving wheel, so as to more quickly overcome some penetration related friction occurring at that instance of initial engagement. Such counter element may take the form of a local counter or guide plate, a rotatable wheel or a rotating belt section. For securing undisturbed filament engagement and directional guidance at even highest possible speeds, such counter element may be extended over the entire section of engagement between drive wheel and filament. Rather than at known counter elements which have the function of exerting a counter force, in particular a counter pinching force for securing filament grip, a counter element may at the present invention be embodied, at least mainly in a simplest form of a fixed, i.e. non rotational guiding plate. It may hence be clear that the present invention also in this respect allows for reduction in number of moving components, which not only renders manufacture simple and economic, but also operationally reduces vulnerability of the driving unit, thereby enhancing operational life time.

Another operational, at least functional advantage of the present invention is that filament retractions may now not only securely, i.e. frictionless be performed, but also at unmatched high speed and over relatively great, i.e. considerably increased amount of length. As if this improvement would not yet be enough, the present invention additionally enables to do so at a virtual endless subsequence of retractions, or of feedings and retractions, which is virtually impossible or at least quite hard to do at conventional systems.

### BRIEF DESCRIPTION OF THE DRAWINGS

Various aspects of the invention and an example of part of an embodiment of the invention is illustrated in the drawings which depart from the general and wide spread knowledge of 3D printing system and extruders therefor, and in which:

FIG. 1 schematically depicts a known filament feeding mechanism of an extruder of an otherwise commonly known 3D manufacturing system;

FIG. 2 is a cross sectional, axial view of a new drive wheel of a new concept, method and mechanism of driving a filament, in accordance with the present invention;

FIG. 3A, in a section of FIG. 2 further illustrates the working principle of the invention while FIG. 3B is a perspective view of the new drive wheel;

FIG. 4A and FIG. 4B respectively represent from a radial stand point, a view of the new drive wheel and a central and radial cross section thereof respectively;

FIG. 5A and FIG. 5B, in line with the view of FIG. 4A, represent alternative embodiments of the new drive wheel, showing different manners of blade incorporation;

FIG. 6A and FIG. 6B illustrate respectively, in views according to FIG. 2 and FIG. 4B, a high speed operation embodiment of the new drive embodied with a guiding element, and a cross section thereof;

FIG. 7A and FIG. 7B, in corresponding manner illustrate a variant of the preceding FIG. 6, in which a rotatable part of the guiding element;

FIG. 8A and FIG. 8B, in a corresponding representation illustrate an embodiment of a kinematic inversion of the new drive method and embodiment of FIG. 2;

FIG. 9A and FIG. 9B again in a corresponding representation illustrate yet a further embodiment of the new driving principle and mechanism by way of sideways feeding and driving of a drive wheel.

FIG. 10A and FIG. 10B illustrate two variants within the scope of the present invention with drive blade tilted forwardly and a filament guiding groove incorporated in a guiding body respectively;

FIG. 11 and FIG. 12 illustrate a further aspect of the present invention in the form of a pre-processed filament, with FIGS. 11A and 12A depicting a longitudinal and central cross section thereof, and FIGS. 11B and 12B providing a perspective view of a filament with pre-fabricated incision, the incision in the embodiment of FIG. 12 at least for an initial part provided open;

FIGS. 13A to 13C depict yet a further embodiment in accordance with the present invention and it's various aspects, with FIG. 13A providing a perspective view of a drive mechanism, FIG. 13B and FIG. 13C each providing a cross sectional view of a drive wheel embodiment, in line with the axis of the drive wheel and transverse thereto respectively, FIG. 13C therein depicting a side elevation of the wheel half with largest diameter as depicted in FIGS. 13A and 13B.

### DESCRIPTION OF ILLUSTRATIVE EMBODIMENTS

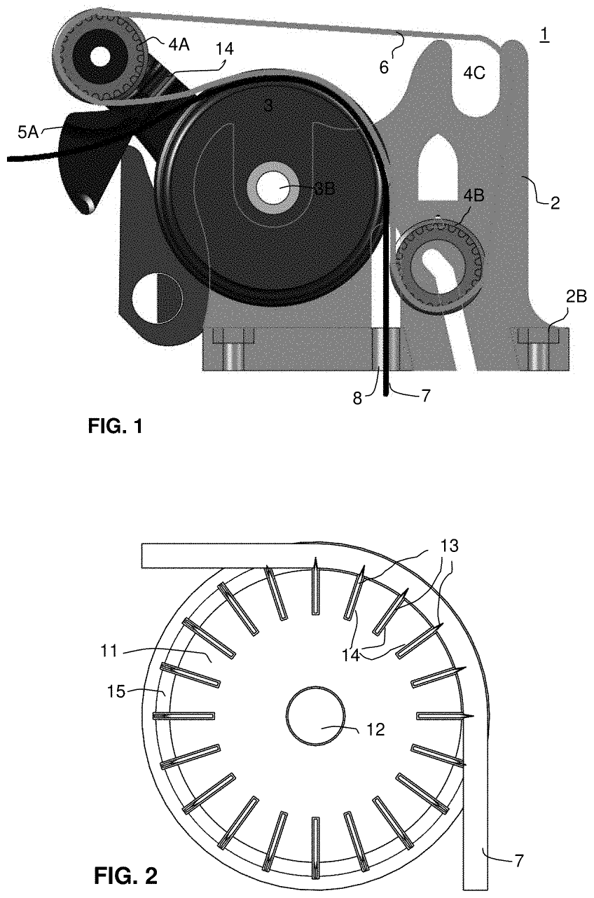

FIG. 1, by way of example of prior art illustrates known filament feeding mechanism unit 1 of an extruder of an otherwise commonly known 3D manufacturing system, commonly denoted in a simplified manner as 3D-printer. It may take the place of any existing filament feeder in virtually any 3D printer, be it e.g. a so called delta printer or a so-called cartesian printer, applying ordinary engineering skills in adapting the feeder interface to such different printer designs. In this case the module is provided with an interface base part to which clamping or fastening elements may be applied for inclusion in a printer, in this case indicated by bolts 2A.

In this example the feeder mechanism module or unit, feeder in short, consists of a support body 2, to be included in a printer by clamping means such as bolts 2B as in this case, which rotatably supports a drive wheel 3 with shaft 3B and guide wheels 4A and 4B, each rotatable around its own shaft. The position of the guide wheels may be adapted in the module by way of ordinary adaptation means such as a slitted opening for a shaft or a repositionable, e.g. rotatable arm 5 supporting guide wheel 4a and its shaft. The guide wheels are included for guiding a drive belt 6 which is slung around each guide wheel 4 and over a section of the drive wheel 3. A third guide or guide wheel, not depicted in the drawing at position 4C finalizes an ordinary infinite belt loop allowing the belt 6 to be freely driven or passed over the drive wheel 3. Using the adaptable feature of the guide wheels 4, the belt 6 may be in greater or lesser extend pressed against the drive wheel 3.

In operation a filament 7 may be fed in between the belt and drive wheel, preferable guided with guiding means such as guide 5A. Due to the pressure between belt 6 and drive wheel 3, the friction between filament and drive and/or pressure means 3 and 6, and the extended length of engagement between filament and pressure means 3 and 6, e.g. over a quarter of the circumference of drive wheel 3, a considerable driving force may be at least virtually slip free exerted on the filament 7, generally a force and drive security considerably larger than the then existing prior art designs.

Incidentally, it may be clear that the driving force is sourced from a drive motor which may be coupled to either or both of one or more of the guide wheels 4A, 4B and 4C and the drive wheel 3. It is also clear that the downward feeding of the printing material filament 7 is guided as much as possible, in this case by base opening 8.

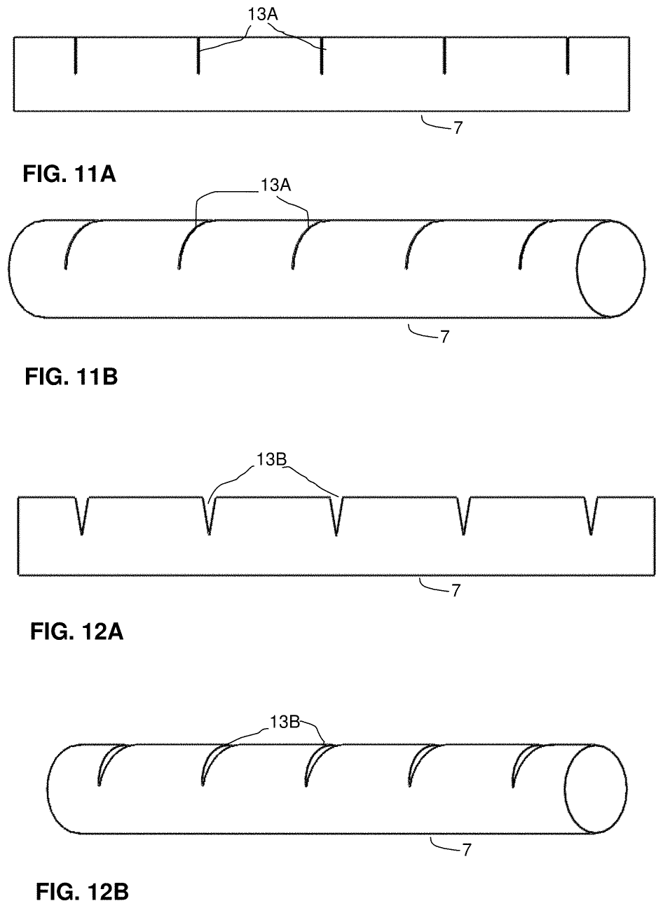

FIG. 2 expresses the new concept underlying the present invention by way of a cross sectional view of a drive system 10, at least a drive mechanism thereof, showing a drive element, in this example embodied by a grooved drive wheel 11 with shaft 12. The depicted section is transverse to the shaft 12, and through the shaft 12, the wheel 11 and a filament 7 depicted in engagement with the drive element 11. The drive element further comprises drive blades 13 which protrude from a drive element surface, in this case circumferential surface in a direction comprising a component transverse to a predetermined direction of movement or drive of the surface of the drive element. In this example the blades are oriented entirely radial, i.e. are oriented entirely transverse to the drive element surface. As expressed by FIG. 10A, the blades, while maintaining a directional component in the axial direction of the drive element, may however equally be oriented somewhat towards the direction of predetermined drive, i.e. may show a directional component in the predetermined direction of drive, in this example in the tangential direction. Put in other words the blades may have a sharp angle with the local direction of drive, which is tangential in case the drive element is embodied as a drive wheel. The drive blades may be and are in this example fittingly received and preferably fixed into pockets 14 created in and/or on the drive element.

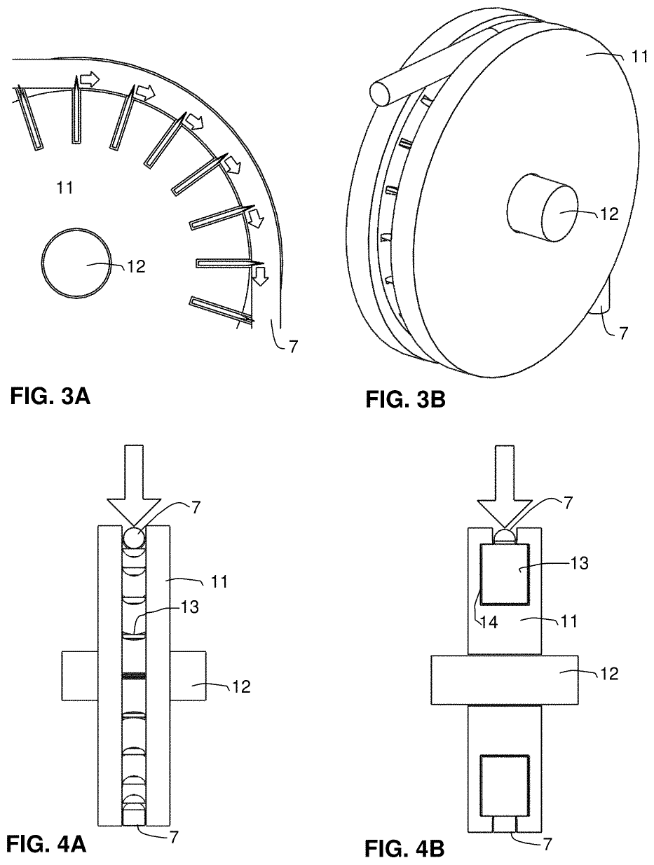

The FIG. 2 drawing depicts wheel drive 11 and filament 7 mutually engaged in driving connection over about a quarter of the circumference of the drive wheel 11, at least of a circumferential groove 15 therein. This groove 15 is further visualized by the perspective view of FIG. 3B, which further clarifies the depth of a groove, in accordance with preference, is of a depth or height virtually matching a filament's diameter, however also preferably is at least of a height matching the radius of a filament or the largest of a set of filaments prescribed for or used with the drive mechanism. As exemplified in FIG. 10B, in a kinematic inversion, the groove may be included in guide element present along the said circumference of a drive wheel. The driving direction is here, in line with the known design of FIG. 1, directed downward, i.e. the filament enters and proceeds from left to right in the drawing, as is further expressed by FIG. 3A in a partial close up of FIG. 2. FIG. 3A otherwise clarifies in drawing that each blade 13, as protruded in accordance with the invention into the filament, exerts a tangential force to the filament while it is in contact therewith over a considerable portion of length thereof, certainly when compared to the known relatively small, hobbed bolt drive as e.g. known from above cited article “extruders-101:-a-crash-course-on-an-essential-component-of-your-3d-printer”. Importantly, rather than the protrusions as known from hobbed bolts, intended for increasing drive friction, the blade feature of the present drive allow the same to protrude into the filament over a considerable part of its diameter. By this feature the blades are capable of exerting a longitudinally directed force to the filament, tangential to the circumference of the drive wheel at virtually every point of mutual contact, from within the filament. This new method of driving thereby steps away from the known idea of improving frictional driving by increasing frictional coefficient or frictional force, in that, as depicted by the arrows in FIG. 3A, the driving force is transferred from the blades to the filament by a blade face oriented preferably at least predominantly transverse to a predetermined or intended longitudinal direction of movement of the filament, more in particular from a non-superficial internal effective point of force application. Using a drive wheel, typically driven by a shaft, hence larger in diameter that the known so called hobbed bolt drive, adds to the powerful drive enabled by the present invention in that, as exemplified by the drawings, such allows to have a multiplicity of blades to be in driving engagement with the filament during its passing over the drive mechanism according to the invention.

In functional sense, FIG. 2 illustrates a method and concept underlying the present invention, according to which blade parts such as knife edged blades are urged towards and in the longitudinal axis of a filament to be driven. In this respect, in a new design thereof in accordance with the present invention, exemplified by way of FIGS. 11 and 12, the filament may be pre-processed, i.e. may be provided with incisions like 13A and 13B into which a blade may relatively easy enter, hence facilitating and optimizing blade protrusion into the filament. However, irrespective of any pre-processing of a filament, the blade may equally be a knife, i.e. knife edged blade, driving into the filament or a blunt blade end protruding into the filament under local squeezing thereof, all with a view to cause a blade to enter into a position relative to the filament form which it may a driving force having a directional component, i.e. preferably at least a considerable directional component in the intended longitudinal direction of the filament. In most cases of a blade engaged with a filament, this implies a tangential direction relative to the drive wheel.

FIGS. 4A and 4B, in a radial view and a cross sectional view respectively, illustrate an embodiment in which a force is applied to the filament, indicated by the top arrow. Such force, at least provided at the location of initial engagement between filament and drive mechanism, may relatively economically be embodied by a stationary guide element 16, such as depicted by FIG. 6A: it has been recognized by the present invention that rotating guidance such as know from and typical for prior art designs is in principle not or hardly required for the present invention given the mutual engagement of driving element and filament, in conjunction with the at least virtually longitudinally directed driving force within the filament. FIG. 4 otherwise illustrates the blade and blade pocket to be preferably of a width larger that the groove width, at least preferably larger than the diameter of a filament applied with, or of the largest one of a set of filaments that may be applied with the drive mechanism.

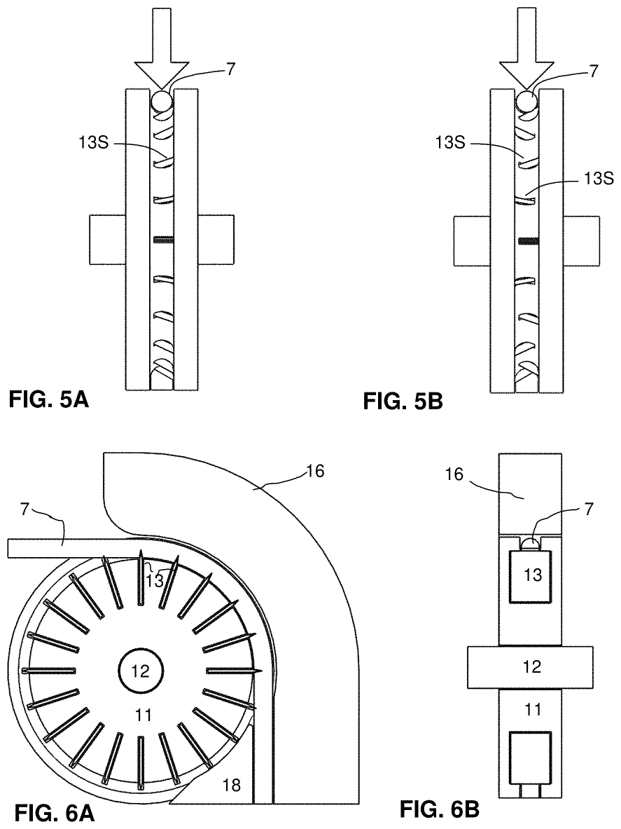

FIGS. 5A and 5B set forth variants on, i.e. merely slightly different embodiments of the concept underlying the invention, in particular of the embodiment depicted by way of FIG. 2 and FIG. 3, in that the blades are incorporated in the drive element with the protruding straight edge under a sharp angle 13S with a drive shaft, at least driving axis of the drive element. Where in the embodiment of FIG. 5A all protruding straight edges are at a same angle, i.e. all have an inclination with at least virtually the same orientation, FIG. 5B depicts a variant in which the protruding blade edges in alternating manner have an oppositely directed orientation. The embodiment may have the advantage that any desired counter element for generating an opposing force, i.e. against the force generated by intrusion of the blade into the filament at entry thereof into the drive mechanism, may be formed within the drive element itself in the form of a side wall of the groove in which the filament is received. Such opposing force or counter element may be desired at entry of the filament into the drive mechanism in case the filament feeder such as winder block is incapable of providing a sufficiently large counter force or resistance for keeping the filament line section between drive mechanism and filament feeder sufficiently straight, at least sufficiently tight for withstanding a resistance force generated at protrusion of a drive blade into the filament without undue buckling of the filament or loss of engagement thereof with the drive mechanism at said instance of entry of the filament into the drive mechanism.

Though not depicted, it goes without saying that rather than with a straight edge, a drive blade may equally be formed spherical, either concave or sickle shaped, or shaped convex, i.e. bulged outward. Both shapes have their own merits, in that concave quickly allows a relatively large circumferential engagement of the filament without a need for deep penetration, hence with less of a need for a counter element at filament entry. The convex shape tends to reduce the penetration resistance at deep entry into the filament, however allows longitudinal force exertion on to the filament from a core point thereof, allowing somewhat greater forces to be entered into the filament. Incidentally, where relatively simple and economically formed straight blade edges may be oriented inclined as described in the preceding, the same feature holds for convex and concave shaped drive blade edges in that the straight basis of these shapes may be take for determining the orientation of these blade embodiments.

FIG. 6A and FIG. 6B depict an embodiment where such counter element is included in the drive mechanism. It is particularly useful in an embodiment with application of blunt drive blades, more in particular when these are used in conjunction with ordinary filament, i.e. without pre-provided incisions, but it may equally be applied in conjunction with knife edged i.e. sharp drive blades. Irrespective of the preceding considerations a counter element may typically also be applied in case of any or both of optimization of exerted drive force and high filament drive speed is desired.

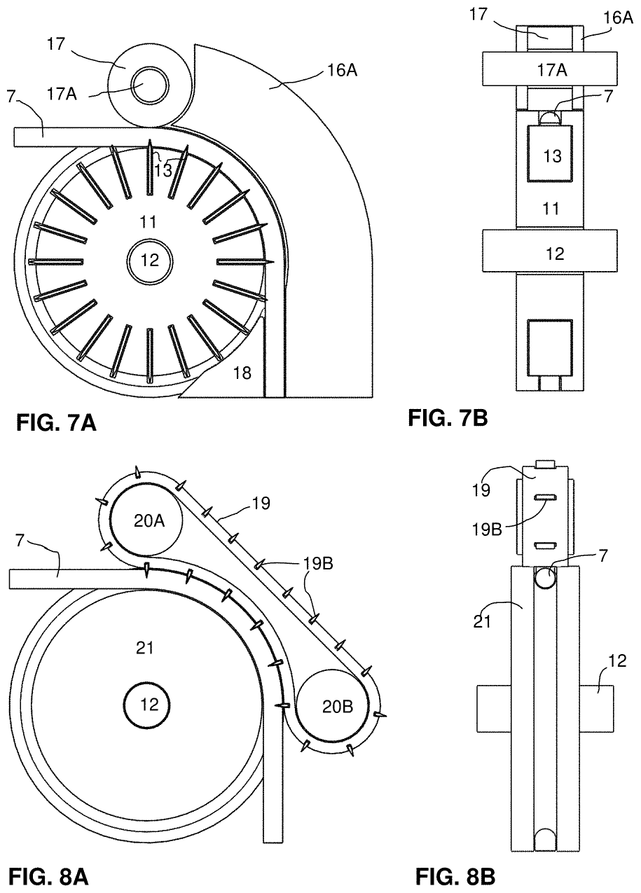

The counter element may in principle only be applied at the location of entry of the filament into the mechanism, however, in particular for high drive speeds and/or high force may be applied for guiding, in fact securing filament position relative to the multiple set of drive blades, in particular for preventing a risk of buckling to a smaller or larger extend as may be present under such circumstances. The latter may in particular occur near or at the exit location of the filament. It was recognized by the present invention that such guiding or security function does not need a friction reducing solution as is in prior art designs provided by way of a set of contacting guiding wheels or belts, so that the counter element may be kept simple and relatively low cost by embodying the same as a stationary element. Yet, in particular where blunt drive blades are applied, any friction is according to the equally solved in a relatively simple manner by application of friction reducing material such as a strip of peek adhered to the counter element face facing the filament and drive element. Yet, as provided by way of the example in FIGS. 7A and 7B, the counter element may be provided in two part form, with a rotatable counter element part 17, here about shaft 17A, at the location of entry of the filament, and a slightly shortened stationary part 16A along the subsequent trajectory of the filament while in engagement with a drive blade.

Especially for large force and high speed applications the counter element may be provided with a further sophistication in the form of a counter element 18, preferably made integral with the in the preceding described counter element 16 and 16A, in the form of a counter element present between the filament 7 and the drive element 11, i.e. drive wheel in FIGS. 6 and 7, at the location of exit of the filament from the drive mechanism. The counter element 18 thereby extends from the circumference of the drive element 11, all the way to the point of exit of the filament from the drive mechanism, preferably in parallel, i.e. opposite to the guide element 16, preventing buckling over said final trajectory and promoting straight feeding of the filament as is in particular desired at high speed and high filament driving force applications.

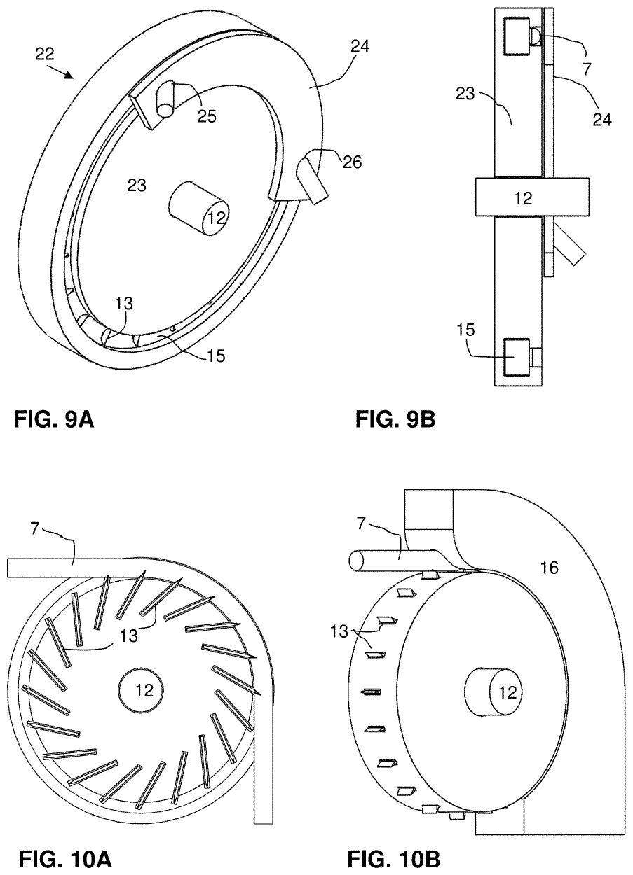

FIG. 8A and FIG. 8B illustrate a kinematic inversion of the filament drive mechanism and concept according to the invention. In this embodiment of the invention the drive element is formed by a flexible track 19 slung around two wheels 20A, 20B, at least one of which being driven and positioned such that a section of a filament to be driven is urged against a wheel shaped counter element 21 of relatively large diameter, essentially the drive wheel 11 with or without knife blades 13, preferably provided with a groove for guiding the filament 7. The drive element 19 of this example is provided with multiple drive blades 19B, preferably knife shaped, such that the filament 7 entered between drive element and counter element is engaged, i.e. is driven by a multiplicity of drive blades Alike the preceding embodiments, the filament is engaged with, at least taken up by the drive mechanism over about and preferably a quarter of the outer diameter of the wheel shaped counter element 21.

Where in the depicted embodiment of FIG. 8, i.e. FIG. 8B, the groove is of a depth in measure corresponding to the diameter of the filament or largest of a set of filaments to be applied, and the drive blades are of a diameter matching or smaller than the groove with, the groove may in accordance with preference as well be provided of more shallow depth, allowing the drive blades to be broader than the width of the groove. In yet another example of various embodiments that may be devised under the present invention, FIG. 9A along with FIG. 9B set forth a drive mechanism embodiment 22 with a bladed groove 15 with blades 13 in a drive wheel 23, e.g. in accordance with the embodiments of one of the figures FIG. 2 to FIG. 7. The groove 15 is now situated sideways in a drive wheel 23 as it were, i.e. with the open side facing in the axial direction of the drive wheel 23. The drive mechanism embodiment is provided with a circularly extending, preferably plated counter element 24. The counter element is preferably provided with dedicated openings 25, 26 for receiving and exiting a to be driven and driven filament section respectively. Likewise as the preceding embodiments, location receipt and exit of the filament in this drive mechanism embodiment 22 are situated at 90 degrees mutual distance along, typically near the periphery of the drive wheel 23.

Where FIGS. 10 to 12 have been discussed in the preceding, and along further embodiments of the invention, it may further be noticed that FIG. 10 also set forth an example of a simplified drive wheel, in that it is hardly or not provided with a groove, the latter being partially or fully included in a guiding element, e.g. guide element 16. On the counter side this embodiment has the dis-advantageous that it is to be shielded in order to prevent fingers from easily touching blades 13 in case the are used with sharp edge.

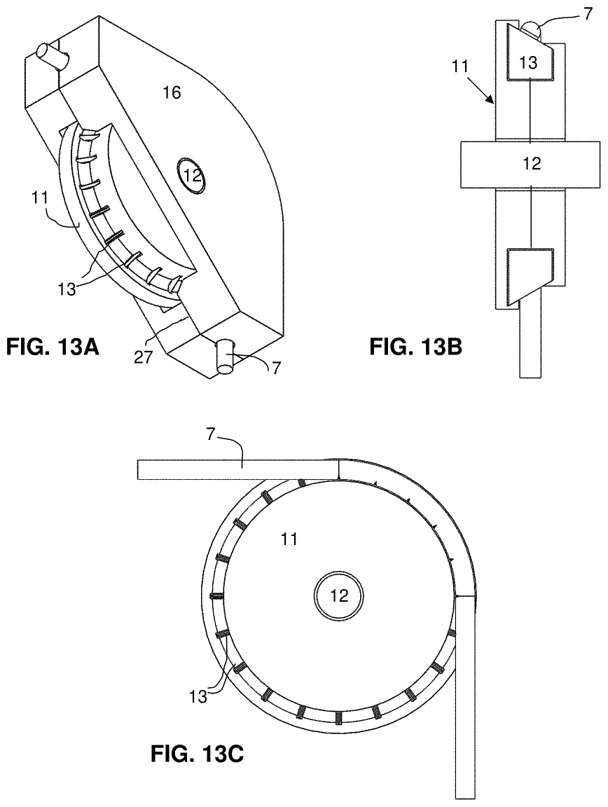

FIG. 13A provides a perspective view of a preferred embodiment of the extruder drive wheel, in which the guide 16 is embodied with side flanges, in a manner that it also partially envelopes the side faces of drive wheel 11, more preferably to the extend that it may accommodate, either enveloping the shaft by play or by bearing the shaft 12 for the drive wheel 11. The guide 16 is in this embodiment divided in two parts, that are attached together, generally shaped as two halves with a mutual interface 27 oriented square to the longitudinal extension of the shaft 12 or else shaft hole therefore. More preferably the interface may be located somewhat eccentrically relative to halfway the thickness, i.e. width of the guide 16.

FIGS. 13A to 13C express yet a further embodiment of a drive wheel 11, in which one half is provided with the outer rim extending at the radial level of a partial groove. The contour of the latter being visible in FIG. 13A and in fact also in FIG. 13C in the other half of the drive wheel 11. FIG. 13B further clarifies that a drive wheel 11 may be shaped in two interconnected halves, in the sense that an interface plane is present preferably oriented transverse to the longitudinal extension of shaft 12 or any shaft hole in the drive wheel 11. FIG. 13B further clarifies that a knife or blade 13 may be prevented from radial escape from it's pocket by an outer rim part of drive wheel 11 which acts as a stop to radial outward movement of a knife or blade 13. FIG. 13 yet further clarifies that the here depicted embodiment is provided with the knife or blade edge that is to engage with filament 7 extending under an acute angle with the central axis of the drive wheel, with the sloping edge oriented or facing towards the drive half with radial lower rim. relative to drive in the here provided out any rim extending extend that and a cross section over a length of shaft 12 of the drive element respectively, of yet another embodiment.

It is finally remarked that the invention encompasses all details as expressed by the following set of claims, whether or not explicitly expressed in the preceding description.

1. A method of operating a 3D printer of a 3D printing based manufacturing system in which a filament of printing material is driven into an extruder head by means of a drive mechanism including a drive element as a filament drive, in which method the filament may be driven by a protrusion protruding from the drive element into the filament in a direction at least having a component transverse to the direction of drive of the filament and by subsequently driving the protrusion into a pre-determined direction of the filament, in particular by driving a wheel or belt holding said protrusion, characterized in that the protrusion is embodied by a blade incorporated in the drive element, the blade forming a driving blade acting in the longitudinal direction of the filament, from penetrating into an incision of the filament.

2. Method according to claim 1, in which said incision is made by said blade during protrusion.

3. Method according to claim 1, in which a directional component of the protrusion is oriented in the axial extension of the drive.

4. Method according to claim 1, utilizing at least one knife edged blade, the knife edged part protruding from a circumferential face of a drive means such as wheel and belt and forced into the filament to be driven.

5. Method according to claim 4, in which said forcing is supported by a counter or guide element at least present during or at the instance of the protruding of a drive blade into the filament.

6. Method according to claim 1, in which the filament is fed into the drive mechanism at an angle different to the outlet angle, the filament routed around a section of the drive wheel, in which in said section a plurality of driving blade forming knives are supported by and protrude from either the circumferential face of a drive wheel or from a drive belt guided along a circumferential face, preferably along a section of the entire circumference.

7. Method according to claim 1, in which a drive blade at driving of a filament is entered into the filament for at least one tenth and at most two thirds of its diameter.

8. Method according to claim 1, in which the filament is received into a circumferential groove, the groove shaped at least largely concave, said groove in particular being included in either one of the drive wheel or part or whole of any one counter element.

9. Method according to claim 8 in which the blades engage and protrude into the filament by an edge part extending under an angle with the axial direction of either the drive wheel or the drive belt supporting the drive blade.

10. Printing material filament, in particular intended for application in accordance with method claim 1, provided with incisions at a fixed, predetermined mutual distance, in particular under an angle of 90 degrees or less with an intended direction of drive of the filament.

11. Drive element for a drive mechanism of an extruder for a 3D printing based manufacturing system, in particular for driving a printing material filament, the element comprising a circumferential face from which drive blades incorporated into the drive element protrude outward, in particular under an angle with a direction of drive.

12. Driving element according to claim 11, in which a drive blade is oriented with a directional component in the axial extension of the drive.

13. Drive element according to claim 11, in which the blades are provided with a knifed edge, intended for cutting or protruding into a filament to be fed into the drive mechanism.

14. Drive element according to claim 11, in which the blades extend at least in a grooved part of either one of the circumferential face of a drive wheel or any counter element cooperating therewith.

15. Drive element according to drive element claim 11, in which the blades protrude outward to an extend within a range of one tenth of a diameter of a virtual groove diameter, to two thirds thereof.

16. Drive element according to drive element claim 11, in which a blade at least partly protrudes from an axial side of the groove, in particular having an direction component in parallel to an axis of the drive element.

17. Drive element according to claim 16, in which subsequent drive blade 11, at least partly extend from opposing sides of the groove, in particular are included in the drive element with blade edges having an opposing directional component.

18. Drive element according to claim 11, in which the drive element is arranged as a drive wheel and wherein a blade is for a largest part fittingly included in, and extending from a pocket thereof.

19. Drive element according to claim 18, in with the drive wheel is embodied with two parts which in conjunction compose said pocket.

20. 3D printer and 3 D printing based manufacturing system, or extruder therefor arranged for executing method claim 1, and/or arranged for cooperation with said filament claim, and/or comprising a drive element, drive mechanism and/or extruder in accordance with any of the related preceding claims.
